(19) United States
(12) Patent Application Publication
(10) Pub. No.: US 2026/0249635 A1
(43) Pub. Date: Aug. 27, 2026

(54) ACTIVATABLE AND THERMALLY SENSITIVE MEDIA ELEMENTS WITH LIGHT SCATTERING LAYER

(71) Applicant: Zebra Technologies Corporation, Lincolnshire, IL (US)

(72) Inventors: Mohannad ABDO, Clifton, NJ (US); Eric W. LIBERATO, Pequannock, NJ (US); Brian S. HUFFMAN, Belle Mead, NJ (US)

(73) Assignee: Zebra Technologies Corporation, Lincolnshire, IL (US)

(21) Appl. No.: 19/065,510

(22) Filed: Feb. 27, 2025

(51) Int. Cl. B41M 5/382; B41M 5/28

(52) U.S. Cl. CPC B41M 5/38271; B41M 5/38221; B41M 5/287

(57) ABSTRACT

Activatable and thermally sensitive media elements with light scattering layer are described herein. An example activatable and thermally sensitive media elements with light scattering layers may be provided by an activatable environmental exposure indicator, including a substrate, an indicator region operatively coupled to the substrate, a light scattering layer covering a covered portion of the indicator region, the light scattering layer formed of a light scattering material having voids such that the covered portion of the indicator region is obscured, and a plurality of activatable microcapsules coupled to the substrate.

### BACKGROUND

Thermally sensitive media elements, such as environmental indicators, may be configured to produce an observable effect, such as a color change responsive to thermal exposures. Thermal print media may be configured to be imparted with indicia by thermal exposure, e.g., from a direct thermal printer. Premature exposures to heat, or high ambient temperatures may render the thermally sensitive media elements spent prior to intended use, or otherwise unusable.

### SUMMARY

In an example embodiment, the present disclosure describes an activatable environmental exposure indicator, including a substrate, an indicator region operatively coupled to the substrate, a light scattering layer covering a covered portion of the indicator region, the light scattering layer formed of a light scattering material having voids such that the covered portion of the indicator region is obscured, and a plurality of activatable microcapsules coupled to the substrate. Each activatable microcapsule of the plurality of activatable microcapsules includes a liquefiable material microencapsulated in a frangible shell. The liquefiable material is configured to liquefy responsive to a predetermined environmental exposure. The frangible shells are configured to release the liquefiable material responsive to an application of an activation action and contain the liquefiable material when liquefied and when solidified, prior to the application of the activation action. The plurality of activable microcapsules is coupled to the substrate in a position where the liquefiable material, after being released from the frangible shells and when liquefied, flows into the light scattering layer and fills the voids of the light scattering layer, such that the covered portion of the indicator region becomes unobscured.

In an example embodiment, the present disclosure provides a direct thermal printable media, including a substrate, a pigmented layer overlaying the substrate, a light scattering layer overlaying the pigmented layer, the light scattering layer formed of a light scattering material having voids such that the light scattering layer obscures the pigmented layer, and a plurality of activatable microcapsules. Each microcapsule of the plurality of activatable microcapsules includes a liquefiable material microencapsulated in a frangible shell. The frangible shells are configured to be ruptured when exposed to a compressive stress above an activation threshold and configured to release the liquefiable material when ruptured. The liquefiable material is configured to liquefy when exposed to heat above a predetermined heat threshold. After the plurality of activatable microcapsules are coupled to the substrate in a position so that when the liquefiable material is released from the frangible shells and when liquefied, the liquefiable material is flows into the light scattering layer and fill the voids, such that areas of pigmented layer aligned with areas of the light scattering layer where the voids are filled with the liquefiable material become unobscured.

In an example embodiment, the present disclosure provides a method of forming indicia on a media element, including providing a substrate layer including a pigmented surface, overlaying the pigmented surface with a light scattering material, the light scattering material having voids configured to obscure the pigmented surface, overlaying the light scattering material with a plurality of activatable microcapsules, thus forming a media element, applying a compressive force to the media element, wherein the compressive force has sufficient magnitude to expose the microcapsules to a compressive stress exceeding the activation threshold, thus rupturing the frangible shells, and applying heat to specified portions of the media element, wherein the heat applied exceeds the predetermined heat threshold, such that the liquefiable material in the specified portions liquefies and flows into the light scattering material and fills the voids in the specified portions, and the pigmented surface becomes unobscured in the specified portions, thus forming indicia in the specified portions. Each microcapsule of the plurality of activatable microcapsules includes a liquefiable material microencapsulated in a frangible shell. The frangible shells are configured to be ruptured when exposed to a compressive stress above an activation threshold and release the liquefiable material when ruptured. The liquefiable material is configured to liquefy when exposed to heat above a predetermined heat threshold.

In an example embodiment, the present disclosure provides a method of forming a media element, including providing a substrate layer, including a pigmented surface, coupling a light scattering material containing voids to the pigmented surface of the substrate layer, forming a light scattering layer, such that the light scattering material obscures the pigmented surface, and dispensing, in a liquified state, a carrier material in which a plurality of activatable microcapsules is embedded. The carrier material is configured to solidify after dispensation, such that each of the plurality of activatable microcapsules are embedded in a solid matrix formed by the carrier material. Each microcapsule of the plurality of activatable microcapsules includes a liquefiable material microencapsulated in a frangible shell. The frangible shells are configured to rupture when exposed to a compressive stress above an activation threshold, releasing the liquefiable material, and contain the liquefiable material when liquefied and when solidified, prior to an exposure to the compressive stress above the activation threshold. The liquefiable material is configured to liquefy when exposed to a temperature above a predetermined temperature threshold. After the liquefiable material is released from the frangible shells and when liquefied, the liquefiable material is configured to flow into the light scattering layer and fill the voids, such that the pigmented surface becomes unobscured.

In an example variation of at least one of the example embodiments, the indicator region includes indicia which is initially obscured by the light scattering layer, and when the voids of the light scattering layer are filled, the indicia become unobscured.

In an example variation of at least one of the example embodiments, the indicia are machine-readable indicia, which is readable through the light scattering layer after the liquefiable material fills the voids and is unreadable through the light scattering layer before the liquefiable material fills the voids.

In an example variation of at least one of the example embodiments, the activatable environmental exposure indicator further includes a flow inhibiting layer disposed between the light scattering layer and the plurality of activatable microcapsules, the flow inhibiting layer configured to inhibit flow of the liquefiable material into the light scattering layer after the liquefiable material is released from the frangible shells and when the liquefiable material is liquefied, such that the covered portion of the indicator region becomes unobscured after a) the liquefiable material has been released from the frangible shells and b) the liquefiable material has been liquefied for a predetermined duration of time following being released from the frangible shells.

In an examples variation of at least one of the example embodiments, the covered portion of the indicator region becomes unobscured after the activation action is applied to the indicator region and the activatable environmental exposure indicator is subsequently exposed to the predetermined environmental exposure for a predetermined duration of time.

In a variation of at least one of the example embodiments, after the liquefiable material fills the voids, the covered portion of the indicator region remains unobscured when the liquefiable material is liquefied, and after the liquefiable material is re-solidified.

In a variation of at least one of the example embodiments, the activation action is an application of a compression stress exceeding an activation threshold, the activation threshold being in a range of 0.1 pounds per square inch (psi) and 10 psi.

In a variation of at least one of the example embodiments, the predetermined environmental exposure is an exposure to an ambient temperature above a predetermined high temperature threshold, an exposure to an ambient temperature above a predetermined high temperature threshold for at least a predetermined amount of time, and a cumulative exposure to ambient heat exceeding a predetermined cumulative heat threshold.

In a variation of at least one of the example embodiments, the liquefiable material is selected from a group consisting of a side-chain crystalline polymer, polyalkyl acylate, an alkane wax, and combinations thereof.

In a variation of at least one of the example embodiments, the light scattering layer is formed of a material selected from a group consisting of a side chain crystalline polymer, Polytetrafluoroethylene (PTFE), Ultra High Molecular Weight Polyethylene (UHMW PE), Ultra High Molecular Weight Polypropylene (UHMW PP), High Density Polyethylene (HDPE) Polyvinvylidene Fluoride (PVDF), Perfluoroalkoxy alkane (PFA), Liquid Crystalline Polymer (LPC), and combinations thereof.

In a variation of at least one of the example embodiments, the plurality of activatable microcapsules is embedded in a carrier material, the carrier material and the plurality of activatable microcapsules forming a matrix layer overlaying the light scattering layer.

In a variation of at least one of the example embodiments, the heat applied to the specified portions is configured to exceed to the predetermined heat threshold in the specified portions but remain below the predetermined heat threshold outside of the specified portions.

In a variation of at least one of the example embodiments, the compressive force is applied by a thermal printer.

In a variation of the embodiment, the heat is applied to the specified portions by a thermal printer.

In a variation of at least one of the example embodiments, the carrier material is dispensed at a dispensation temperature greater than the predetermined temperature threshold.

In a variation of at least one of the example embodiments, the carrier material is configured to solidify after dispensation responsive to cooling below a solidification temperature greater than the predetermined temperature threshold and less than the dispensation temperature.

In a variation of at least one of the example embodiments, the method further includes, prior to dispensing the carrier material and after coupling the light scattering material to the pigmented surface of the substrate layer, coupling a flow inhibiting layer to the light scattering material, the flow inhibiting layer configured to inhibit flow of the liquefiable material into the light scattering layer after the liquefiable material is released from the frangible shells and when the liquefiable material is liquefied.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates a microcapsule, according to embodiments of the present disclosure.

FIGS. 2A-2E illustrate views of a thermally sensitive media element, according to embodiments of the present disclosure.

FIGS. 3A-3D illustrate view of a thermally sensitive media element with a flow inhibiting layer, according to embodiments of the present disclosure.

FIGS. 4A-4B illustrate views of a media element configured as a high temperature excursion type activatable environmental exposure indicator, according to embodiments of the present disclosure.

FIGS. 5A-5B views of a media element configured as a time-temperature type activatable environmental exposure indicator, according to embodiments of the present disclosure.

FIGS. 6A-6C illustrate views of a media element configured as a thermal printable media element, according to embodiments of the present disclosure.

FIG. 7 illustrates a flowchart of a method for forming indicia on a media element, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to media elements utilizing light scattering layers which have an obscuring form and a non-obscuring form. The media elements of the present disclosure further include activatable microcapsules containing a liquefiable material which may be employed to transition the light scattering layer from the obscuring form to the non-obscuring form, e.g., by filling voids in the light scattering material. The media elements of the present disclosure may be configured as direct thermal printable media elements, and as activatable environmental exposure indicators, as non-limiting examples.

Previous examples of media elements including light scattering layers have been proposed, however many such examples involve melting the light scattering layer, or portions thereof, so that the light scattering layer, or a portion thereof, transitions from the obscuring form to the non-obscuring form. In such examples, the light scattering layer is configured to transition from the obscuring form to the non-obscuring form when exposed to temperatures or heat inputs in excess of the melting temperature of the light scattering layer. A user may desire to cause the light scattering layer to transition from the obscuring form to the non-obscuring form by a selective application of heat. However, if the media element is exposed to high-heat ambient conditions, the light scattering layer may transition from the obscuring form to the non-obscuring form prematurely, or in portions of the light scattering layer undesired by the user.

To help address this issue, the media elements of the present disclosure are activatable, and are generally configured to prevent premature transitions of the light scattering layer from the obscuring form to the non-obscuring form, prior to the application of an activation action (e.g., by a user). The media elements of the present disclosure may include activatable microcapsules, which may be contained in a matrix layer overlaying the light scattering layer. The activatable microcapsules may include a liquefiable material having a similar index of refraction to the light scattering material of the light scattering layer. Prior to an application of an activation action to the media element, the liquefiable material remains contained in the microcapsule, and the light scattering layer remains in the obscuring form, even if sufficient heat exposure occurs to potentially liquify the material in the microcapsules. After the microcapsules are ruptured responsive to the application of the activation action, the liquefiable material is released from the microcapsules and the media element becomes “activated”. After being activated, when the media element is exposed to temperatures in excess of a melting point or liquefaction temperature of the liquefiable material, the liquefiable material liquefies and flows into the light scattering layer, transitioning the light scattering layer form the obscuring state to the on obscuring state.

The discussion contained in the following detailed description has been organized as follows:

Section I: Some Relevant Materials and Notable Properties Thereof.

Section II: Rupturable Microcapsules

Section III: Embodiments of Media Elements.

### Section I: Some Relevant Materials and Notable Properties Thereof

### Liquefiable Materials

Various embodiments of activatable environmental exposure indicators discussed herein utilize a liquefiable material that can be configured to react to an environmental exposure, such as temperature, humidity, gas exposure or the like. In particular, in many embodiments the liquifiable materials responds by liquifying in response to temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. With regard to the rapidity or quickness of state changes, the materials discussed herein which are suitable for the disclosed applications preferably have melting range or glass transition spanning less than 10 degrees C, more preferably spanning less than 5 degrees C, and most preferably spanning 1 degree C or less.

In addition to transitioning from a solid phase to a liquid phase over a small temperature range, some suitable materials discussed herein transition from a liquid phase to a solid phase over a similarly small temperature range. Once the environmental exposure temperature has been exceeded, a drop in temperature below the environmental exposure will cause almost immediate solidification of the liquefiable material.

As used herein, the term “liquid phase” is used to describe a state of a material in which the material is capable of fluid flow. Similarly, the terms “liquefaction” and “liquefy” and other variations across parts of speech, are used to describe the transition in which a material not in the liquid phase enters the liquid phase. The terms “liquefaction point” and “liquefaction temperature” are used to describe a temperature, or temperature range, at or in which a material may undergo liquefaction.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “predetermined environmental exposure” is used to describe an exposure to an environmental or ambient condition exceeding (e.g., either positively or negatively) a known or otherwise predetermined exposure threshold. In various embodiments, a predetermined environmental exposure may be an exposure to a temperature exceeding a predetermined temperature threshold. Various liquefiable materials discussed herein are configurable such that the liquefiable material liquefies responsive to a predetermined environmental exposure. In some embodiments, one or more liquefiable materials which liquefy at a particular temperature corresponding to a predetermined environmental exposure may be selected for use in the disclosed applications, and in other examples, liquefiable materials may be modified or formulated such that the liquefiable material liquefies at a particular temperature corresponding to the predetermined environmental exposure.

According to some embodiments, some liquefiable materials may have a shared liquefaction point and solidification point, in which the liquefiable material liquefies and solidifies about temperature range less than 1 degree C. In other examples, the liquefiable materials discussed herein may exhibit hysteresis, where the solidification temperature is substantially lower (e.g., more than 1 degree C.) than the liquefication temperature. In some embodiments, the liquefaction and solidification temperatures are within about 0.1 degrees C., within about 0.5 degrees C., within about 1.0 degrees C., within about 1.5 degrees C., within about 2 degrees C., within about 2.5 degrees C., within about 3.0 degrees C., within about 3.5 degrees C., within about 4.0 degrees C., within about 4.5 degrees C., within about 5 degrees C., or within about 10 degrees C. of each other.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable. Useful synthetic polymers can also be hydrophobic, if desired. Suitable liquefiable materials include side-chain crystallizable polymers (e.g., various particular methacrylates, such as poly(hexadecylmethacrylate); polyalkyl acrylate; a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms.).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate) , poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate and octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

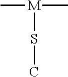

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide—will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine-or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326(1953 ) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6C), and —M— is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

The liquefiable materials which are suitable for deployment in the disclosed applications may be further selected or configured for particular properties when liquefied, such as viscosity, as a non-limiting example. Generally, viscosity of a liquified material (e.g., liquefied liquefiable material) corresponds to molecular weight of the molecules in the liquefied material. As such, a liquefiable material may be selected or configured to have a particular molecular weight in order to achieve a particular viscosity when liquefied.

With regard to SCC materials in particular, the melting point of SCC materials may be tuned by increasing the side-chain length of the molecules of the SCC material, and the viscosity (when liquefied) may be tuned by increasing the quantity of side chains of the molecules of the SCC material, thus increasing the molecular weight.

In addition to SCC polymers, suitable liquefiable materials for the disclosed applications may include non-SCC polymers, polymeric waxes, synthetic waxes, natural waxes and combinations thereof.

According to some embodiments, a first liquefiable material may be combined with a second liquefiable material to form a combined liquefiable material which has a liquefication point distinct from the liquefication points of either the first or second liquefiable materials.

Various liquefiable materials suitable for use in the disclosed applications may have melting points or liquefaction points across a broad range of temperatures. Useful liquefiable materials may have a melting point or liquefaction point between 0 degrees C. and 100 degrees C., although temperatures above 100 degrees C. and below 0 degrees C. are also contemplated.

### Frangible Shells

Various embodiments of activatable environmental exposure indicators discussed herein utilize microcapsules having frangible shells, which are employed to microencapsulate a payload of other materials (e.g., liquefiable materials and indicator materials), forming a microcapsule. The frangible shells are rupturable, such that the frangible shells rupture and release the payload when subjected to an activation action.

The microcapsule is initially in an unruptured form, capable of being configured to transition to a ruptured form when ruptured by exposure to an activation action, (e.g., the application of heat, pressure, and/or a combination of heat and pressure exceeding a predetermined threshold). In the unruptured form, the frangible shell of the microcapsule maintains separation between the contents of the microcapsule and any external environmental stimuli and/or contains a phase change of the contents of the microcapsule in response to any external environmental stimuli. Prior to activation (e.g., exposure to the activation action), the frangible shells of a microcapsule contain the payload of the microcapsule when the payload is liquefied, solidified, undergoing a phase change, and in any other material states the payload may experience in the usable ranges of the devices of the present disclosure.

The frangible shell may be ruptured by applying an activation action to the microcapsule exceeding a predetermined activation threshold. The activation action may cause the frangible shell to fracture, melt, break, dissolve, sublime, become porous, or otherwise disengage, allowing the release of the contents of the frangible shell, generally referred to herein as “rupturing”.

The frangible shells may have one or more of various rupture modes (or weakening modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action that later activates the microcapsule.

A first rupture mode is rupture or weakening by externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

A second rupture mode is rupture or weakening by heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some such examples, activation may be achieved by applying a high temperature for a very short interval, e.g., a few milliseconds. For example, the mass or heat of fusion of the payload may be much greater than the mass or heat of fusion of a barrier that needs to be removed, allowing a short exposure to high temperature to remove or alter the microcapsule without significantly affecting a thermally sensitive payload contained in the microcapsule.

A third rupture mode is rupture or weakening via an internally applied pressure. In some such examples, the microcapsules may be ruptured or weakened by a source of internal pressure, where the activation action is configured to trigger expansion of a material within the frangible shell (e.g., a volatile material, thermally expandable microsphere) which increases the internal pressure of the microcapsule, which ruptures or weakens the frangible shell.

In some such examples, the predetermined activation threshold corresponds to a radial stress or a hoop stress (e.g., acting on the frangible shell) of sufficient magnitude to rupture the frangible shell. In some examples, the predetermined activation stress threshold is a radial stress or hoop stress exceeding about 0.1 pounds per square inch (psi), a radial stress or hoop stress exceeding about 0.5 psi, a radial stress exceeding about 1 psi, a radial stress exceeding about 2 psi, a radial stress or hoop stress exceeding about 5 psi, a radial stress or hoop stress exceeding about 10 psi, or a radial stress or hoop stress exceeding about 15 psi. The activation stress ranges given are purely exemplary and the microcapsules can be formed to respond to other stress ranges.

Microcapsules which are configured to rupture via the first mode, externally applied pressure, may be formed of one or more of several materials and from one or more of several processes in order to meet user specifications. Generally, materials suitable for forming frangible shells which are configured to rupture via the first mode are categorizable into three groups, including polymers, elastomers and inorganics.

Some polymers suitable for forming frangible shells which are configured to rupture via the first mode are listed below, as nonlimiting examples.

Polyurethane (PU): PU is generally flexible, and resilient to pressure, and the pressure sensitivity can be tailored to various use cases through alterations in formulation.

Polylactic Acid (PLA): PLA is generally brittle, and the pressure sensitivity can be tailored to various use cases by increasing or decreasing the degree of crystallinity. An additional benefit is that PLA is biodegradable.

Ethyl Cellulose: ethyl cellulose has good film forming properties, and is modifiable for specific mechanical responses, such as abrasion, puncture, and crushing.

Poly(lactic-co-glycolic acid) (PLGA): PLGA has tunable mechanical properties and the pressure sensitivity is tailorable through alterations in formulation.

Poly(methyl methacrylate) (PMMA): PMMA is brittle under mechanical stress, relatively transparent, and the pressure sensitivity is tailorable through adjustment of shell thickness.

Polyamides (Nylon): Nylon has high strength and resilience, and pressure sensitivity varies by species and can be tailored though alterations in formulation and processing.

Polymelamine Formaldehyde: Polymelamine formaldehyde is hard and brittle, and specific burst pressures are application specific.

Polyurea Formaldehyde: Polyurea formaldehyde is hard and brittle, and pressure sensitivity varies with crosslinking density.

Some elastomers suitable for forming frangible shells which are configured to rupture via the first mode are listed below, as nonlimiting examples.

Silicone elastomers: silicone elastomers are highly flexible, with high elasticity, and can be engineered for specific pressure sensitivities.

Natural rubber: natural rubber has good elasticity and flexibility; pressure sensitivity can be adjusted via cross-linking and formulation.

Styrene-Butadiene Rubber (SBR): SBR has good abrasion resistance, modifiable for different pressure thresholds.

Polybutadiene rubber: polybutadiene rubber has high resilience, good impact resistance, may be blended to adjust pressure sensitivity.

Nitrile Butadiene Rubber (NBR): NBR has good oil and chemical resistance and is customizable for specific mechanical properties.

Some inorganics suitable for forming frangible shells which are configured to rupture via the first mode are listed below, as nonlimiting examples.

Silica: silica can form brittle shells which have a high thermal stability.

Calcium Carbonate: Calcium carbonate may be used as a filler to modify mechanical properties and contributes to brittle rupture behavior.

Alumina (Aluminum Oxide): Alumina has high mechanical strength, can be brittle, and may be useful in rigid shell applications.

Borosilicate Glass: Borosilicate glass is brittle under stress and has high thermal and chemical resistance.

Zinc Oxide: Zinc Oxide is brittle under pressure, and also offers UV protection when used in coatings.

In the above examples, material selection is dependent on payload material so as for chemical interactions to be avoided. Then, specific burst pressures are highly dependent on the thickness of the shell paired with the degree of crosslinking. Additionally, tailoring the molecular weight and introducing other materials to the formulation, such as plasticizers or fillers can adjust the burst pressure. Due to the extent of independent variables, experimental determination is required to establish exact burst pressures.

Microcapsules which are configured to rupture via the first mode, externally applied pressure, may be formed of one or more of several materials and from one or more of several processes in order to meet user specifications. Several non-limiting examples are given below.

Spray drying, which involves atomizing a solution or suspension of the shell material and core material into a hot chamber, where rapid solvent evaporation forms solid microspheres. The mechanical properties may be controlled by the composition and processing parameters.

Emulsion polymerization, in which monomers are emulsified in a continuous phase and polymerized to form microspheres. The mechanical properties of the shell can be tailored by selecting appropriate monomers and crosslinking agents.

Coacervation/Phase Separation is a process where a polymer-rich phase separates from a polymer-poor phase to encapsulate the core material. Solidification of this phase forms microspheres with controllable mechanical properties.

Solvent Evaporation, in which the polymer and core material are dissolved in a volatile organic solvent, then emulsified in an aqueous phase. As the solvent evaporates, microspheres with specific mechanical properties are formed.

Interfacial Polymerization in which polymerization occurs at the interface between two immiscible phases, forming a polymer shell around the core material. The thickness and composition of the shell can be controlled to influence its rupture characteristics.

Microfluidics is precise technique where droplets are formed in microfluidic devices and solidified to form microspheres. This provides for precise control over the size and mechanical properties of the microspheres.

Microcapsules which are configured to rupture via the second mode, heat exposure, may be formed of one or more of several materials and from one or more of several processes in order to meet user specifications. Generally, materials suitable for forming frangible shells which are configured to rupture via the heat exposure are categorizable into three groups, including polymers, waxes and inorganics.

Some polymers suitable for forming frangible shells which are configured to rupture via the second mode are listed below, as nonlimiting examples. Many of the following materials are described with references to melting ranges. In some examples, a material may exhibit multiple properties of solids, fluids, or gels when at a temperature within the melting range. In some examples, certain formulations of a material may transition from a solid phase to a viscous or liquid phase at a distinct point, or smaller range within the melting range, and other formulations of the same material may transition from a solid phase to a liquid or viscous phase at another district point or another smaller range within the melting range. Generally, it is understood that when a material is at a temperature above the melting range, the material is expected to exhibit viscous or liquid phase characteristics, and when the material is at a temperature below the melting range is expected to exhibit solid phase characteristics.

Polyethylene (PE): PE has a melting range between 115 and 135 degrees C., is chemically resistant, impact resistant, and low cost.

Polyvinyl Alcohol (PVA): PVA can be configured to decompose between 180 and 190 degrees C. and has good film forming properties. Additionally, PVA is water soluble and biodegradable.

PU: PU has a wide glass transition phase, and no distinct melting point, however PU is highly flexible and elastic, and is resistant to abrasion and impacts.

Polystyrene (PS): PS has a melting range between 240 and 270 degrees C. and is relatively low cost. Transparent grades of PS have good clarity.

PMMA: PMMA has a melting range between 160 and 165 degrees C., and has excellent optical clarity, good weather resistance, and high surface hardness.

PLGA: PLGA has a melting range between 50 and 60 degrees C., which is tunable into higher and lower ranges with compositional ratios. PLGA is biodegradable, biocompatible, and has a tunable degradation rate.

Polycaprolactone (PCL): PCL has a melting range between 58 and 63 degrees C., is biodegradable, has a low melting point which provides for ease of processing, good flexibility

Polypropylene (PP): PP has a melting range between 130 and 170 degrees C., is generally lightweight, chemically resistant and fatigue resistant.

Nylon: The melting point of nylons and other amides varies with species, but generally bounded between 190 and 350 degrees C. Nylons and amides have high strength and toughness, good thermal stability, and excellent wear resistance.

Ethylene Vinyl Acetate (EVA): EVA has a melting point between 85 and 90 degrees C., good flexibility and resilience, low-temperature toughness, and has a transparent and glossy appearance.

Cellulose Acetate: Cellulose Acetate decomposes between 230 and 300 degrees C., is biodegradable, has good transparency and gloss, and has excellent film-forming properties.

Poly(ethylene glycol) (PEG): PEG has a melting range between 50 and 60 degrees C., which varies with molecular weight. PEG is water soluble, biocompatible, and has low toxicity.

Some waxes suitable for forming frangible shells which are configured to rupture via the second mode are listed below, as nonlimiting examples.

Paraffin Wax: Paraffin wax has a melting range between 46 and 58 degrees C. and can be tuned to have sharp melting points.

Microcrystalline wax: Microcrystalline wax has a melting range between 60 and 90 degrees C., has high toughness, high flexibility and is thermally stable.

Carnauba Wax: Carnauba wax has a melting range between 82 and 86 degrees C., is naturally occurring and has a high specific hardness.

Montan Wax: Montan wax has a melting range between 72 and 92 degrees C. and has good thermal stability.

Polyethylene (PE) Wax: PE wax has a melting range between 90 and 120 degrees C., high chemical resistance, and good mechanical strength.

Candelilla Wax: candelilla wax has a melting range between 68 and 72 degrees C., has good binding properties, and is naturally occurring.

Fischer-Tropsch Wax: Fischer-Tropsch wax has a tunable melting range up to 110 degrees and is highly crystalline with good thermal stability.

Some inorganics may be used to form frangible shells which are configured to rupture via the second mode, however the melting points of many such substances may exceed 800 degrees C., and some such inorganic materials are not suitable for the disclosed applications.

Microcapsules which are configured to rupture via the second mode, heat exposure, may be formed of one or more of several materials and from one or more of several processes in order to meet user specifications. Several non-limiting examples are given below.

Many of the processes used to form microcapsules configured to rupture via the first mode may also be used to produce microcapsules configured to rupture via the second mode. Some such processes are emulsion polymerization, spray drying, coacervation/phase separation, solvent evaporation, and interfacial polymerization, each of which is described above.

In addition to these processes, freeze drying, or lyophilization, may also be used to form microcapsules configured to rupture via the second mode. Freeze drying involves freezing a solution or suspension of the encapsulating material and core, then sublimating the solvent to leave behind microspheres.

Microcapsules which are configured to rupture via the third mode, internally applied pressure, may utilize any of the above materials according to user specifications. Rupturing a microcapsule with internally applied pressure involves microencapsulating a volatile material and applying heat to the microcapsule, triggering a rapid expansion of the volatile material which ruptures the frangible shell. In some examples, it may be advantageous to form microcapsules configured to rupture via the third mode from the same materials used to from microcapsules configured to rupture via the first mode. Many such examples are heat resistant, such that the frangible shell is not affected by the applied heat used to volatilize the volatile material. Conversely, it may be advantageous to form microcapsules configured to rupture via the third mode from the same materials used to from microcapsules configured to rupture via the second mode. Since the activation action for the third mode is similar to that of the second mode, the applied heat may weaken the frangible shell, such that the volatile material has less resistance when rupturing the microcapsule.

Speaking generally of microcapsules which are suitable for deployment in the disclosed applications, the microcapsules may be any size, and in various embodiments, have outer diameter lengths between 20-1000 micrometers (μm), and generally between 50 and 700 μm. The frangible shells may be any size smaller than or equal to the outer diameter of the microcapsule. The microcapsules can have a thickness between 5 to 25 μm. The payload ratio, or the ratio of the total weight of the payload within the microcapsule to the entire weight of the microcapsule including the contents contained within the microcapsule, can range from 20 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

### Light Scattering Materials

The media elements of the present disclosure include light scattering layers. Generally, a light scattering layer which is suitable for use in the disclosed applications has an obscuring form and a non-obscuring form. The light scattering layer may be formed of a light scattering material.

Light scattering materials may include a plurality of voids. The voids may be configured to scatter light passing through the light scattering material.

As used herein, “scattering” may describe a wide range of physical processes where moving particles (e.g., photons) or radiation of some form (e.g., light), is forced to deviate from a straight trajectory by localized non-uniformities (including particles or voids) in the medium through which they pass. Deviations in the trajectory may also be caused by reflections of radiation (e.g., light). Reflections of radiation that undergo scattering are often does called diffuse reflections and unscattered reflections are called specular (mirror-like) reflections. Without being bound to a particular theory, at an atomic level, “scattering” refers to particle-particle collisions between molecules, atoms, electrons, photons and other particles. In the illustrated example, “scattering” may be caused by non-uniformities, such as voids in the light scattering material. The non-uniformities may exist on the light scattering material's surface, within the light scattering material, or a combination thereof. However, the types of non-uniformities which can cause scattering, sometimes known as “scatterers” or “scattering centers”, may include particles, bubbles, droplets, density fluctuations in fluids, crystallites in polycrystalline solids, defects in monocrystalline solids, surface roughness, cells in organisms, textile fibers in clothing among others. The effects of such features on the path of almost any type of propagating wave or moving particle can be described in the framework of scattering theory. In several of the examples described herein, the “scatterers” are voids, which may be voids within particles of material, voids between particles of material, voids in the surfaces of particles of material, voids within a solid mass of material, or spaces formed between particles of material.

Generally, when light is passing through the light-scattering material, the voids (along with other non-uniformities) may cause the light to deviate from a straight trajectory and the aggregate effect of each instance of scattering causes the light-scattering material to be non-transparent or opaque. When the light scattering material appears opaque, the light scattering material is in the obscuring form, and may be used to obscure object or indicia from view.

When in bulk form, (e.g., homogenized so as not to include voids) the base materials used to form light scattering materials may be generally transparent (e.g., non-light scattering), and are subsequently processed into a form which is light scattering. The light scattering layers of the present disclosure are generally formed of a transparent material which has been particlized and compounded into a layer where voids exist between the particles of transparent material. The spaces between the particles of transparent material provide surfaces within the layer for incident light to scatter off of, which at scale, renders the light scattering material to appear opaque.

For use in the disclosed applications, light scattering layers must also be convertible or otherwise transformable to a non-obscuring, or non-light scattering state. In some examples, the light scattering layer may be acted upon by a compressive force, a thermal input, or some other external action which causes, by compression, melting, or other action, the voids in the light scattering material to collapse. In other examples, the voids of the light scattering material may be filled with a liquid, or liquefiable material, which is transparent, the filling of the voids causing the light scattering effect to abate, such that the light scattering layer transitions to the non-obscuring form.

In the above-described manner, light scattering materials may be used to initially obscure objects or indicia from a viewer, and later reveal the initially obscured object or indicia when the voids of the light scattering material are collapsed or filled.

The light scattering material may include a uniform arrangement of voids that are evenly distributed throughout the material, or allocated towards certain features, such as a surface, of a light scattering layer.

An example of a light scattering layer may include a polymer which is particlized and physically compounded to form a light scattering material. Some such suitable polymers include Polytetrafluoroethylene (PTFE), Ultra High Molecular Weight Polyethylene (UHMW PE), Ultra High Molecular Weight Polypropylene (UHMW PP), High Density Polyethylene (HDPE) Polyvinvylidene Fluoride (PVDF), Perfluoroalkoxy alkane (PFA), Liquid Crystalline Polymer (LPC). In some examples, the polymer which forms the light scattering layer is a side-chain crystalline polymer.

Some suitable materials for forming a light scattering layer may include SCC polymers, which are polymers with crystalline segments attached to the main polymer chain, offering enhanced refractive index and structural properties that improve light scattering capabilities, titanium dioxide (TiO2), zinc oxide (ZnO), calcium carbonate (CaCO3), polymeric microspheres such as those made from polystyrene or PMMA, hollow sphere pigments, silica, alumina (aluminum oxide), nanosilver, nanogold, quantum dots, cholesteric liquid crystals, cellulose nanocrystals, starch derivatives, blends of organic and inorganic materials, barium sulfate (BaSO4), magnesium carbonate (MgCO3), talc, kaolin clay, mica, titanium oxynitride (TiON), yttrium oxide (Y2O3), cerium oxide (CeO2), antimony-doped tin oxide (ATO), indium tin oxide (ITO), zirconia (ZrO2), boron nitride (BN), hexagonal boron nitride (h-BN), lanthanum oxide (La2O3), and gadolinium oxide (Gd2O3).

For SCC polymers, generally, light scattering happens when there is a variation in the refractive index caused by particles or voids. In Emulsion-based SCC polymers, polymer particles ranging from 400 to 700 nm in size, along with air voids between these particles, are optimal for achieving the desired light scattering effect. The SCC emulsion polymer is especially noteworthy because these polymer particles can melt and coalesce into a clear, transparent film. This characteristic sets them apart from other particles that cause light scattering, as those particles do not change with temperature in the way that SCC polymer particles do.

An example of a light scattering layer may include a micropillar array film, a nanopillar array film, or the like. The films may be prepared by laser etching the film to create an appropriate surface profile including the voids. In another example, the light scattering material may be prepared by chemical deposition.

### Section II: Rupturable Microcapsules

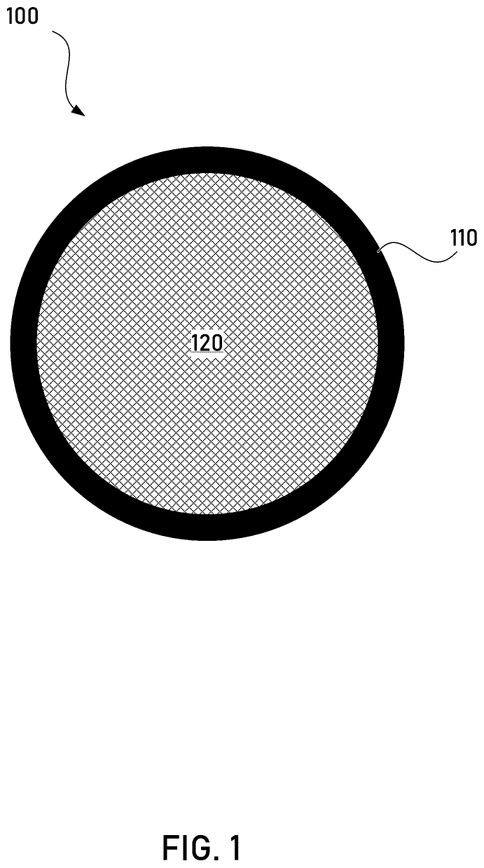

FIG. 1 illustrates a cross-sectional view of a microcapsule 100, as may be used in media elements, according to embodiments of the present disclosure.

The microcapsule 100 includes a frangible shell 110 which contains a payload 120. In various examples, the frangible shell 110 is configured to contain the payload 120 until an activation action is applied to the microcapsule 100, responsive to which the frangible shell 110 is configured to rupture, or otherwise disengage, and release the payload 120. The frangible shell 110 may include any of the features of frangible shells discussed above in Section I and may be constructed of one or more of the materials discussed above in Section I.

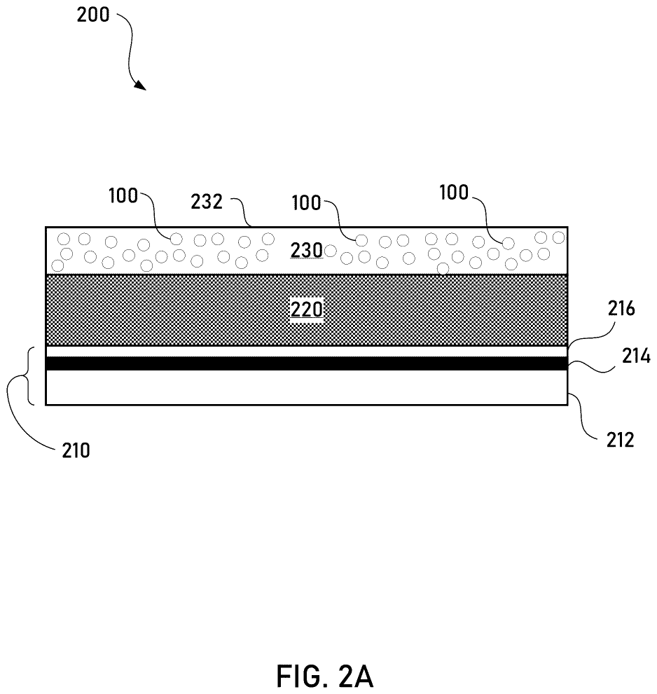

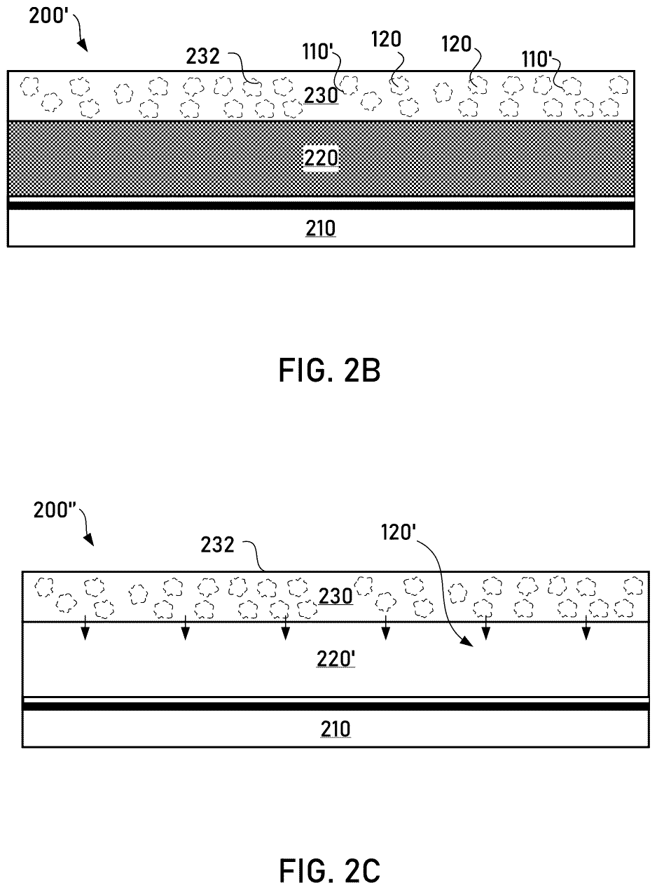

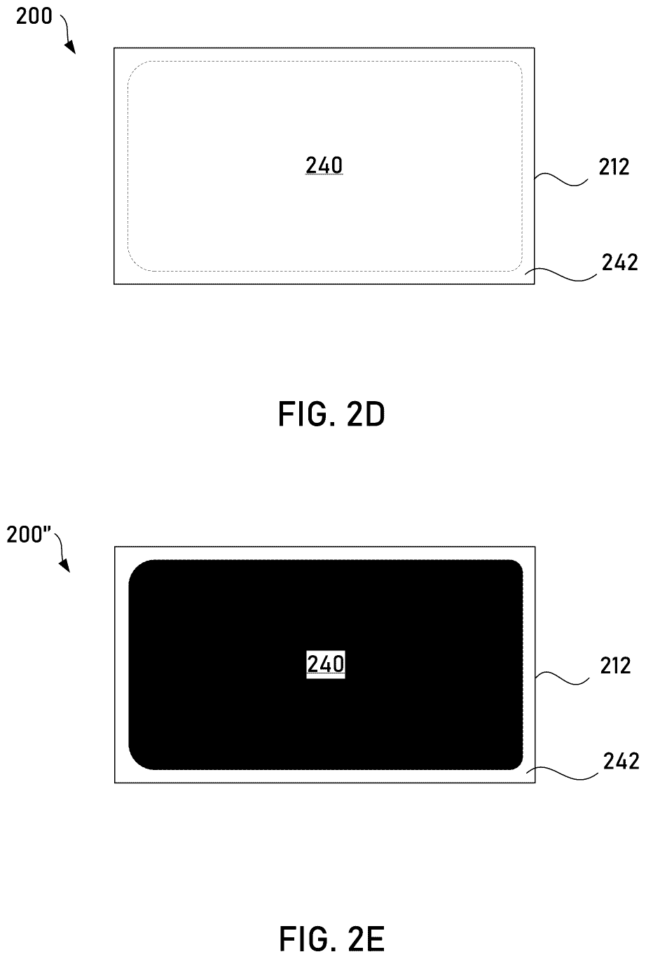

In some examples, the payload 120 includes a liquifiable material combined with an indicator material, which may be configured to produce an effect (e.g., in tandem with elements of a media element (see FIGS. 2A-6C)) when the liquefiable material transitions from a solid phase to a liquid phase.

In the present disclosure, the payload 120 includes a sufficient proportion of the liquefiable material that when the liquefiable material liquefies, the payload 120 as a whole, notwithstanding embedded or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

According to some embodiments, the liquefiable material of the payload 120 may be one of, or a combination of the liquefiable materials listed above in Section I. Furthermore, the indicator material may be one of, or a combination of, the indicator materials listed above in Section I. Moreover, payload 120 materials (e.g., liquefiable materials and indicator materials) may be selected according to other features or design constraints of the indicators with which the microcapsules 100 are to be employed. Some liquefiable materials may exhibit advantageous properties with some wicks, some light scattering materials, some temperature ranges, and so forth.

The microcapsule 100 may be any size, but in one such embodiment, has an outer diameter length between 20 to 1000 micrometers (μm). The frangible shell 110 may be any size smaller than or equal to the outer diameter of the microcapsule 100A. The frangible shell 110 can have a thickness of between 5 to 25 μm. The ratio of the total weight of the contents (e.g. thermally expandable microsphere 130, payload 120) within the microcapsule 100A to the entire weight of the microcapsule 100A including the contents contained within the microcapsule 100A, can range from 50 percent to 90 percent. A variety of frangible shell 110 materials may be chosen, depending on the application, and the nature of the payload 120 of the microcapsule 100. In general, the frangible shells 110 should resist the passage, whether by flow, diffusion, or migration, of the payload 120 of the microcapsule 100A, prior to activation.

Generally speaking, the microcapsule 100 is configured to be activated responsive to an application of an activation action, or in some examples, two activation actions. When activated, the frangible shell 110 of the microcapsule 100A is disengaged, such that the payload 120 of the microcapsule 100 is exposed to the environment. When the payload 120 is exposed to the environment, an exposure to the predetermined environmental exposure causes the payload 120 to transition to the liquid state. In this manner, when the payload 120 is exposed to the environment, the payload 120 is primed to begin sensing, or is environmentally sensitive.

The microcapsule 100 may be “activated” or ruptured by exposing the microcapsule 100 to an activation action (e.g. activation stress, activation exposure, activation event, etc.) exceeding a predetermined activation threshold. The activation action may cause the microcapsule 100 to fracture, melt, break, dissolve, sublime, become porous, or otherwise disengage, allowing the release of the contents of the microcapsule 100.

In some examples, the frangible shell 110 of the microcapsules 100 is configured to be ruptured by an externally applied pressure. In such embodiments, the activation action is a compressive stress, or a shearing stress, where the predetermined activation threshold is a stress exceeding about 0.1 pounds per square inch (psi), a stress exceeding about 0.5 psi, a stress exceeding about 1 psi, a stress exceeding about 2 psi, a stress exceeding about 5 psi, a stress exceeding about 10 psi, or a stress exceeding about 15 psi.

In some examples, the frangible shell 110 of a microcapsule is configured to be ruptured by an externally applied heat. In such embodiments, the activation action is an application of heat which is applied conductively, convectively, radiatively, or in combination. When the payload 120 of the microcapsule 100 is heat or temperature sensitive, activation may be achieved by applying a high temperature for a very short interval, e.g., a few milliseconds. For example, the mass or heat of fusion of the payload 120 may be much greater than the mass or heat of fusion of the frangible shell 110, allowing a short exposure to high temperature to remove or alter the microcapsule without significantly affecting a thermally sensitive payload contained in the microcapsule.

In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In various examples, the payload 120 may be configured to liquefy responsive to an exposure to an ambient temperature above a predetermined high temperature threshold, an exposure to an ambient temperature above a predetermined high temperature threshold for at least a predetermined amount of time, and a cumulative exposure to ambient heat exceeding a predetermined cumulative heat threshold. In various examples, the predetermined high temperature threshold may be between 0 degrees C. and 200 degrees C., although other ranges are contemplated. In some examples, the payload 120 may be configured to liquefy responsive to a net heat input, where the net heat input is between 10 kilojoules per kilogram (kJ/kg) and 1000 kJ/kg.

### Section III: Media Elements

FIG. 2A illustrates a cross-sectional view of a media element 200, according to embodiments of the present disclosure. The media element includes a substrate layer 210, a light scattering layer 220, and a matrix layer 230. The substrate layer 210 is overlaid by the light scattering layer 220, which is in turn overlaid by the matrix layer 230. FIG. 2A illustrates the media element 200 in an initial, unactivated stage, as the media element 200 may be provided to an end user.

The substrate layer 210 includes a substrate 212, a pigmented layer 214 and, in some examples, a sealing layer 216. The substrate 212 is generally configured to support the various components and feature of the media element 200 and may extend beyond the profile other components of the media element 200. The pigmented layer 214 overlays the substrate 212 and includes a pigment or is otherwise colored in a manner which visually differentiates the pigmented layer 214 from other components of the media element 200. In some examples, the substrate a 212 and pigmented layer 214 may be integrated, and provided by dying the substrate 212 or by providing a pigmented substrate. The sealing layer 216 is generally configured to isolate the pigmented layer 214 (and generally the substrate layer 210) from contact with any of the materials contained or included in that layers above the sealing layer 214 (e.g., light scattering layer 220 and matrix layer 230). The sealing layer is preferably transparent, such that the pigmented layer 214 is viewable through the sealing layer 216.

The light scattering layer 220 is formed of a light scattering material as discussed above in Section I. Generally, the light scattering layer 220 overlays the substrate layer 210 and includes voids distributed throughout the light scattering layer 220. The voids act as “scatterers” and cause incident light to scatter, resulting in the light scattering layer 220 appearing opaque when viewed. As the light scattering layer 220 is opaque, the light scattering layer 220 is initially in an obscuring form and obscures the portions of the substrate layer 210 which the light scattering layer 220 overlays. Thus, when the media element 200 is viewed, the pigmented layer 214 is obscured by the light scattering layer 220, and the media element 200 appears opaque.

The matrix layer 230 includes a plurality of microcapsules 100. The microcapsules 100 include a payload 120 microencapsulated in a frangible shell 110. The payload 120 of the microcapsules 100 includes a liquefiable material which is configured to liquefy when exposed to temperatures above a predetermined temperature threshold, or to a net heat input above a predetermined heat input threshold. The frangible shells 110 are configured to contain the payload 120 prior to the application of an activation action to the media element 200 and release the payload 120 when the activation action is applied to the media element 200. The activation action may be one, or a combination of activation actions discussed above in Section I.

The microcapsules 100 may be embedded in the carrier material 232, and/or adhered to the light scattering layer 220 by the carrier material 232. In some examples, the carrier material 232 may be a liquefiable material, where the carrier material is dispensed onto the media element 200 in a liquid state and containing the microcapsules 100, whereupon being dispensed, the carrier material 232 solidifies to a solid state, suspending the microcapsules in a solid matrix. In such examples, the carrier material 232 containing the microcapsules 100 may be dispensed at a temperature above the melting point of the payload 120, where the frangible shells 110 are relied upon to contain the payload 120 prior to an application of an activation action. The carrier material 132 may be selected or configured to have a melting point which is substantially above the operating temperature range of the media element 200, such that the carrier material 232 does not liquefy during use and compromise the integrity of the media element 200.

In other examples, the carrier material 232 may be dispensed as a liquid or gel, where after dispensation, the carrier material 232 cures or dries, bonding the microcapsules 100 to the media element 200. In some such examples, the microcapsules 100 may be contained in the carrier material 232 when dispensed, or may be dispensed prior to the carrier material 232, and the carrier material 232 is dispensed over the microcapsules 100.

Generally, the carrier material 232 is transparent, so as not to obscure any layers below the matrix layer 230. In various embodiments, the microcapsules 100 may be transparent or substantially transparent, or be dispersed throughout the matrix layer 230 in a manner that does not obscure the layers below the matrix layer 230.

FIGS. 2A-2C illustrate cross sectional views of the media element 200 in various stages of activation and exposure. FIG. 2A illustrates an initial stage of the media element 200 when the media element 200 is provided or acquired. The light scattering layer 220 is in the obscuring form, and the microcapsules 100 contained in the matrix layer 230 are intact or otherwise unruptured (e.g., “prior to activation”, “unactivated”).

FIG. 2B illustrates the media element 200′ after the activation action has been applied (e.g., “after activation”, “activated”). Following the application of the activation action, the frangible shells 110′ of the microcapsules 100 are ruptured and the payloads 120 are released. The payloads 120 remain in a solid state, as the requisite heat input or thermal exposure has not occurred to liquefy the payloads 120 (e.g., “prior to exposure”, “unexposed”).

The activation action may be one, or a combination of any of the activation actions described above in Section I. In some examples, the activation action is the application of a compressive force, which causes the frangible shells 110 of the microcapsules 100 to rupture. In other examples, the activation action is a heat exposure above a predetermined activation threshold. In some such examples, the heat exposure is of a sufficiently short duration that a thermally sensitive payload 120 is not liquefied by the activation action. In various examples, both a compressive force activation action and a heat exposure activation action may be applied by a thermal printer, possibly as a single simultaneous operation, or one immediately following the other. In some examples, an initial heat exposure may be provided to weaken the frangible shells 110 of the microcapsules, followed by a compressive force which ruptures the weakened frangible shells 110 of the microcapsules 100.

FIG. 2C illustrates the media element 200″ after activation and after the payloads 120′ have been liquefied, responsive to an exposure to a temperature above the predetermined temperature threshold or responsive to a net heat input above a predetermined net heat input threshold (e.g., “after exposure”, “exposed”). The liquefied payload 120′ flows from the matrix layer 230 into the light scattering layer 220, where the liquefied payload 120′ fills the voids of the light scattering layer 220, abating the light scattering effect, rendering the light scattering layer transparent and in the non-obscuring state. In this manner, the pigmented layer 214 is viewable to a user through the light scattering layer 220′ in the non-obscuring form.

Generally, the payload 120 may be selected or configured such that that the payload 120, or the liquefied payload 120′ may have a similar refractive index to the light scattering material of the light scattering layer 220. In this manner, when the liquefied payload 120′ fills the voids of the light scattering layer 220, the light scattering layer 220 (in the non-obscuring form) is rendered to be substantially transparent. In various examples, difference in the refractive index between the payload 120 and the light scattering material of the light scattering layer 220 is preferably less than 0.5, more preferably less than 0.25, and most preferably less than 0.1.

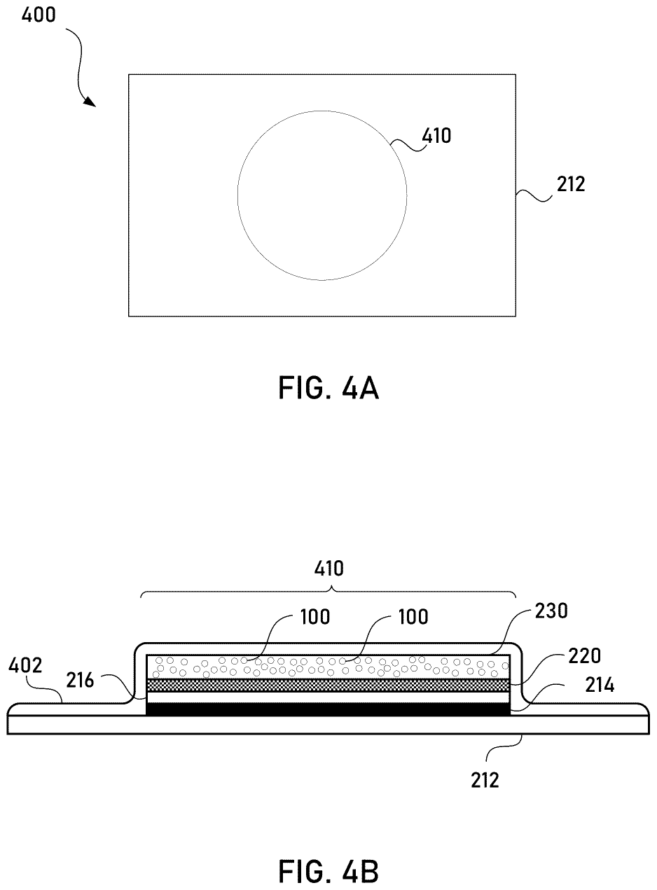

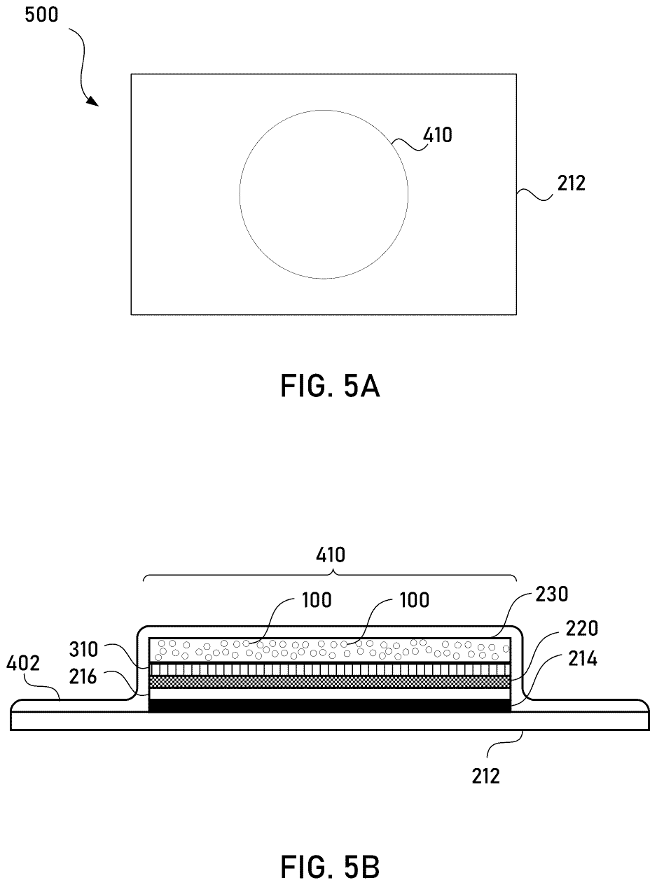

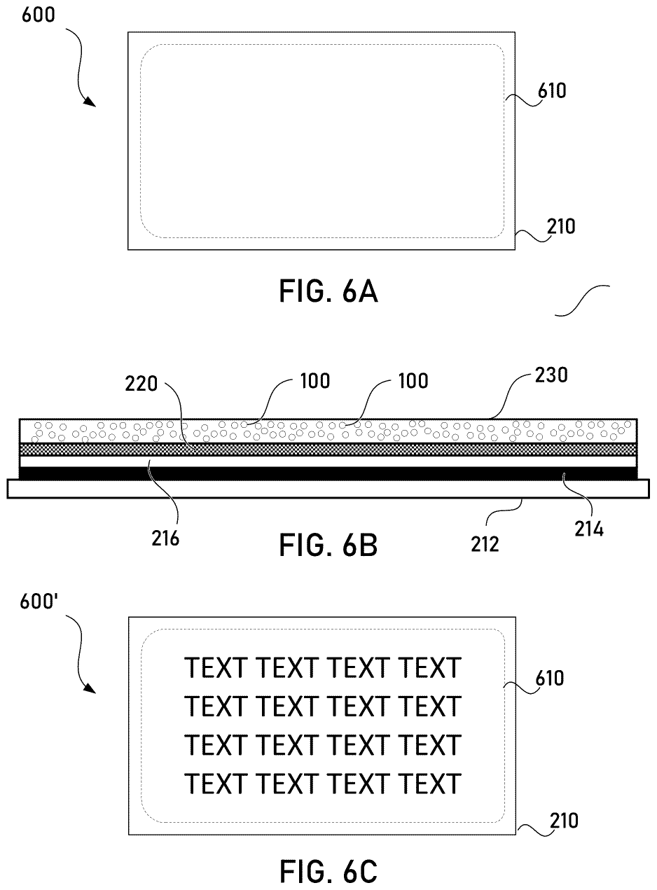

FIG. 2D illustrates a profile view of the media element 200 prior to exposure, where the media element may be activated or unactivated (e.g., as there may be no visibly discernible difference between the activated and unactivated forms), according to embodiments of the present disclosure. The media element 200 may include an active region 240 and a border region 242. The active region 240 includes the components shown and described with reference to FIGS. 2A-2C. In examples where the media element is configured as a printable media element (see FIG. 6A-6C), the active region 240 may be a printable region. In examples where the media element 200 is configured as an activatable environmental exposure indicator (See FIGS. 4A-5B), the active region 240 may be configured as an indicator region. Generally, the border region 242 may simply be a protrusion of the substrate layer 210, or of the substrate 212 beyond the active region.

As illustrated in FIG. 2D, the light scattering layer 220 is in the obscuring form, and the active region 240 of the media element 200 appears opaque. In some examples, the substrate may be colored similarly to the opaque color state of the light scattering layer 220 in the obscuring form (or vice versa) such that the media element 200 appears substantially homogeneous (in terms of color state) when viewed prior to activation and exposure.

FIG. 2E illustrates a profile view of the media element 200″ after activation and after exposure, where the liquefied payload 120′ has flowed into the light scattering layer 220 and transitioned the light scattering layer 220′ to the non-obscuring form. In the non-obscuring form, the light scattering layer 220′ is transparent, such that the pigmented layer 214 is viewable to a user. Said differently, when the media element 200″ is activated and subsequently exposed, the active region 240 has the apparent color state of the pigmented layer 214.

In various examples, the light scattering layer 220 remains in the non-obscuring state when the liquefiable material resolidifies, (e.g., due to subsequent cooling or otherwise). Some payloads 120 may be configured or selected to have a similar refractive index to the light scattering material of the light scattering layer 220, when the payload is solidified and when the payload 120′ is liquefied.

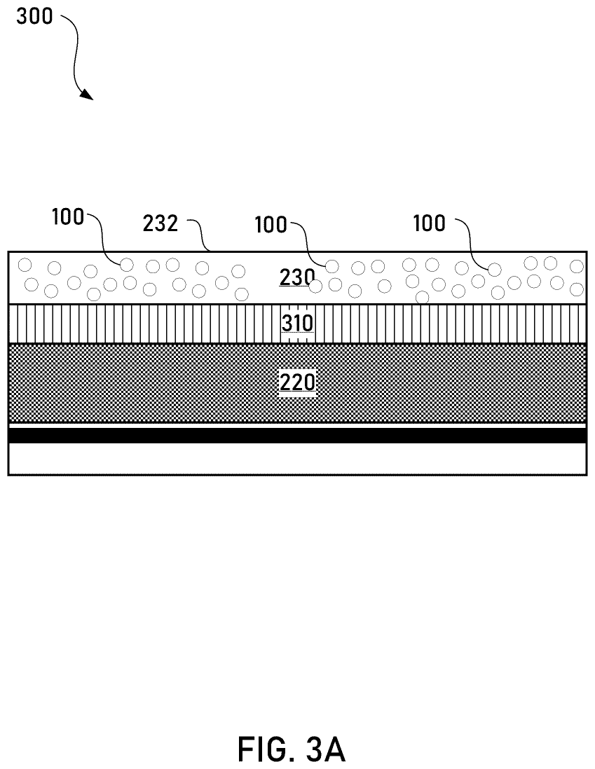

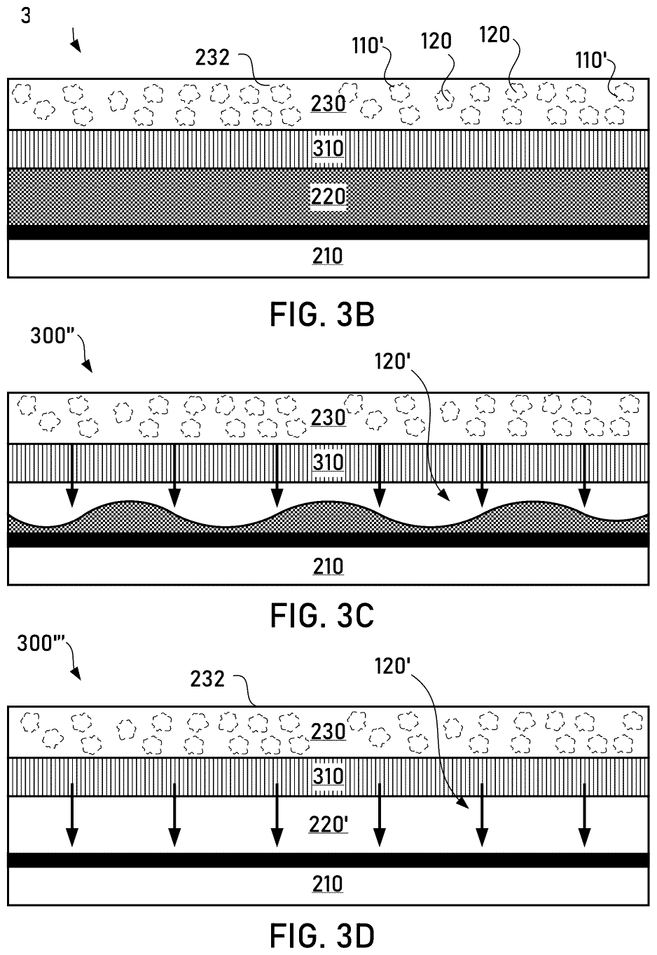

FIG. 3A illustrates a cross section of a media element 300, which is an example variation of the media element 200, including a flow inhibiting layer 310 disposed between the matrix layer 230 and the light scattering layer 220, according to embodiments of the present disclosure. The flow inhibiting layer 310 is generally configured to inhibit the flow of liquefied payload 120′ into the light scattering layer 220, such that the liquefied payload 120 flows into the light scattering layer 220 at lower rate. In this manner, the transition of the light scattering layer 220 from the obscuring form to the non-obscuring form may be delayed relative to the payload 120 liquefying.

In various examples, the flow inhibiting layer 310 may include a porous or microporous material through which the liquefied payload 120′ wicks to reach the light scattering layer 220. In some examples, the flow inhibiting layer 310 may include a plurality of microchannels through which the liquefied payload 120′ passes to reach the light scattering layer 220. In various examples the flow of the liquefied payload 120′ through the flow inhibiting layer 310 may be aided by gravity, capillary action, wicking and other such phenomena to reach the light scattering layer 220.

Similarly to the matrix layer 230, the flow inhibiting layer 310 may be transparent or substantially transparent, so as not to obscure the pigmented layer 114 when the light scattering layer 220′ is in the non-obscuring form.

FIG. 3B illustrates the media element 300′ after activation and prior to exposure. Following the application of the activation action, the frangible shells 110′ of the microcapsules 100 are ruptured and the payloads 120 are released, according to embodiments of the present disclosure. The payloads 120 remain in a solid state, as the media element has not been exposed following activation.

FIG. 3C illustrates the media element 300″ at a time after activation and exposure, when the liquefied payload 120′ is flowing through the flow inhibiting layer 310 and into the light scattering layer 220 but has not permeated the light scattering layer 220 to an extent to fully transition the light scattering layer 220 from the obscuring form to the non-obscuring form, according to embodiments of the present disclosure. Said differently, the liquefied payload 120′ has filled some of the voids in the light scattering material, and portions of the light scattering layer 220 may have become transparent, however at least a portion of the light scattering layer 220 remains in the obscuring form.

FIG. 3D illustrates the media element 300′″ at a time after activation and exposure, when the liquefied payload 120′ has flowed through the flow inhibiting layer 310 and filled the voids of the light scattering layer 220 such that the light scattering layer 220′ is in the non-obscuring form, according to embodiments of the present disclosure. In this manner, the pigmented layer 214 is viewable to a user through the light scattering layer 220′ in the non-obscuring form.

FIG. 4A-4B illustrate views of an example embodiment of a media element 200 configured as an activatable environmental exposure indicator 400, according to embodiments of the present disclosure. The activatable environmental exposure indicator 400 may be a high temperature excursion indicator. The activatable environmental exposure indicator 400 includes a substrate 212, and an indicator region 410. The indicator region 410 includes a pigmented layer 214, a light scattering layer 220, and a matrix layer 230. In some examples, the indicator region 410 includes a sealing layer 216 in between the pigmented layer 214 and the light scattering layer 220. In some examples, the activatable environmental exposure indicator 400 includes a cover layer 402.

Generally, the activatable environmental exposure indicator 400 is configured such that when an activation action is applied to the indicator region, the microcapsules 100 in the matrix layer 230 rupture, releasing the payload 120. The payload 120 includes a liquefiable material which is configured or selected to liquefy responsive to an exposure to a temperature above a predetermined exposure threshold. When exposed to a temperature above the predetermined exposure threshold, the payload 120 liquefies and flows into the light scattering layer 220, where the liquefied payload 120′ fills the voids of the light scattering layer 220, transitioning the light scattering layer from the obscuring form to the non-obscuring form. When the light scattering layer 220′ is in the non-obscuring form, the pigmented layer 214 is viewable to a user. In some examples, the pigmented layer 214 has a color state which visibly contrasts with the color state of the substrate, or with the color state of the light scattering layer 220 in the obscuring form. In some examples, the pigmented layer 214 includes indicia, which are initially obscured by the light scattering layer 220 in the obscuring form and are revealed when the light scattering layer 220′ is in the non-obscuring form. Said differently, the indicia become unobscured when the light scattering layer 220 transitions form the obscuring form to the non-obscuring form.

In various examples, the indicia may be machine-readable indicia, such as a QR code or a barcode. In such examples, the machine-readable indicia may be unreadable, or unscannable when the light scattering layer 220 is in the obscuring form, and the machine-readable indicia becomes readable or scannable when the light scattering layer 220′ is in the non-obscuring form.

In some examples the indicia are in the form of natural language text or symbols. In some examples, when the activatable environmental exposure indicator 400 is configured to be used with a host product having a spoiled temperature, the indicia may include, as a non-limiting example, the word “spoiled” which is initially obscured, and is then revealed when the activatable environmental exposure indicator 400 is exposed to a temperature above a spoiling temperature for the host product.

As an example, the activatable environmental exposure indicator 400 may be configured such that the activation action is a compressive force applied to the indicator region 410, and the predetermined exposure threshold is 40 degrees C. Prior to a user applying the compressive force to the indicator region 410 (e.g., by thumb pressure or otherwise), the activatable environmental exposure indicator 400 may be exposed to temperatures above the predetermined exposure threshold without the light scattering layer 220 transitioning form the obscuring for to the non-obscuring form. Once the user applies the activation, the microcapsules 100 are ruptured, and the payload 120 is released, thus the activatable environmental exposure indicator 400 may begin environmental sensing. Once the activatable environmental exposure indicator 400 is exposed to a temperature above 40 degrees C., the payload 120 liquefies and transitions the light scattering layer 220 to the non-obscuring form.

In various examples, the predetermined temperature threshold may be in a range of about 0 degrees C. to about 220 degrees C. The above ranges are purely exemplary, and activatable environmental exposure indicators 500 may be formed to respond to other temperature ranges and for other amounts of time.

In various examples, multiple activatable environmental exposure indicators 400 may be combined, integrated, or housed in a single media element.

In a non-limiting example of a media element, three activatable environmental exposure indicators (e.g., activatable environmental exposure indicator 400) are integrated onto a single media element, e.g., housed on a single substrate (e.g., substrate layer 210, substrate 212). Each activatable environmental exposure indicator include a distinct type of microcapsule (e.g., microcapsule 100) having a distinct payload (e.g., payload 120). In the a first activatable environmental exposure indicator, a first payload of the first microcapsules is configured to liquefy responsive to a thermal exposure above 40 degrees C., a second payload of the second microcapsules in the second activatable environmental exposure indicator is configured to liquefy responsive to a thermal exposure above 45 degrees C. and a third payload of the third microcapsules in the third activatable environmental exposure indicator is configured to liquefy responsive to a temperature above 50 degrees. By selectively applying activation actions to one or more activatable environmental exposure indicators of the media element, a user may select which exposures are indicated by the media element when such exposures occur.

FIGS. 5A-5B illustrate views of an example embodiment of a media element 300 configured as an activatable environmental exposure indicator 500, according to embodiments of the present disclosure. The activatable environmental exposure indicator 500 may be a time temperature indicator. The activatable environmental exposure indicator 500 includes a substrate 212, and an indicator region 410. The indicator region 410 includes a pigmented layer 214, a light scattering layer 220, a flow inhibiting layer 230 and a matrix layer 230. In some examples, the indicator region 410 includes a sealing layer 216 in between the pigmented layer 214 and the light scattering layer 220. In some examples, the activatable environmental exposure indicator 500 includes a cover layer 402.

Generally, the activatable environmental exposure indicator 400 is configured such that when an activation action is applied to the indicator region, the microcapsules 100 in the matrix layer 230 rupture, releasing the payload 120. The payload 120 includes a liquefiable material which is configured or selected to liquefy when exposed to temperatures above a predetermined temperature threshold and solidify when exposed to temperatures below the predetermined temperature threshold. When exposed to a temperature above the predetermined exposure threshold, the payload 120 liquefies and flows into the flow inhibiting layer 310. The flow inhibiting layer 310 may be configured such the liquefied payload 120′ takes a predetermined period of time while liquefied to migrate through the flow inhibiting layer 310 and fill the voids of the light scattering layer 220. If (after activation) the activatable environmental exposure indicator 500 is exposed to temperatures below the predetermined temperature threshold after the payload 120 is liquefied, the liquefied payload 120′ solidifies, which halts migration of the payload 120 through the flow inhibiting layer 310, and the payload 120 ceases to fill more voids in the light scattering layer 220. When once again exposed to temperatures above the predetermined temperature threshold, the payload 120′ liquefies again and resumes migration through the flow inhibiting layer 310 and resumes filling voids in the light scattering layer 220. In this manner, the liquefied payload 120′ fills the voids of the light scattering layer 220, transitioning the light scattering layer from the obscuring form to the non-obscuring form only after the activatable environmental exposure indicator 500 has been activated and after the activatable environmental exposure indicator 500 has been exposed to temperatures above the predetermined temperature threshold for at least a predetermined amount of time.

In various examples, the predetermined temperature threshold may be in a range of about 0 degrees C. to about 220 degrees C. In various examples the predetermined amount of time may be in a range of about 1 minute to about 24 hours. The above ranges are purely exemplary, and activatable environmental exposure indicators 500 may be formed to respond to other temperature ranges and for other amounts of time.

In some examples, the predetermined amount of time may be tuned by changing a thickness of the flow inhibiting layer 310, a viscosity of the liquefied payload 120′, a pore or channel size of the flow inhibiting layer 310, or a void size of voids in the light scattering layer 220.

FIGS. 6A-6C illustrate views of an example embodiment of a media element (e.g., media element 200 or media element 300) configured as a thermal printable media 600 (e.g., direct thermal printable media), according to embodiments of the present disclosure. The thermal printable media 600 generally includes a substrate 212, a pigmented layer 214, a light scattering layer 220, and a matrix layer 230 including a plurality of microcapsules 100 embedded in a carrier material 232. In terms of the media element 200, the active region 240 is configured as a printable region 610 in the thermal printable media 600. In various examples, the thermal printable media 600 ma include a sealing layer 216 disposed between the pigmented layer 214 and the light scattering layer 220. In some examples, the thermal printable media 600 may include a flow inhibiting layer disposed between the light scattering layer 220 and the matrix layer 230.

In some examples, in a thermal printer, the printhead and the platen roller of the thermal printer form a nip, which applies a compressive force to media which is being processed by the thermal printer. The thermal printable media 600 may be configured such that the activation action which ruptures the microcapsules 100 in the matrix layer 230 of the thermal printable media 600 is the compressive force applied by the nip of the thermal printer. Thus, the compressive force applied by the nip applies the activation action to the microcapsules 100 releasing the payloads 120 from the frangible shells 110. When heating elements of the thermal printhead are activated, the payloads 120 in the portion of the thermal printable media 600 proximate to the activated heating elements are liquefied, and the liquefied payload 120′ flows into the portions of the light scattering layer 220 immediately proximate to, or otherwise vertically aligned with, the activated heating elements. The light scattering layer 220 may be configured such that the liquefied payload 120′ may only flow down (e.g., in a direction from the matrix layer 230 towards the substrate 212, the direction orthogonal to a plane of the substrate 212) and does not spread outwardly (e.g., along the plane of the substrate) such that only the portions of the light scattering layer 220 which are most proximate to the activated heating elements are transitioned from the obscuring state to the non-obscuring state. In this manner, precise indicia may be formed on the thermal printable media 600 as in the portions of the light scattering layer 220 where the voids are filled by the liquefied payload 120′, the pigmented layer 214 is viewable to a user. In various examples, the indicia may include symbols, natural language text, and other indicia which are conventionally printable by a thermal printer.

As a non-limiting example, the thermal printable media 600 is configured as a direct thermal printable adhesive label. The substrate layer may include an adhesive backing, and overlay a release layer, the release layer configured to be selectively removed such that the media element 600 may be subsequently adhesively coupled to a host product.

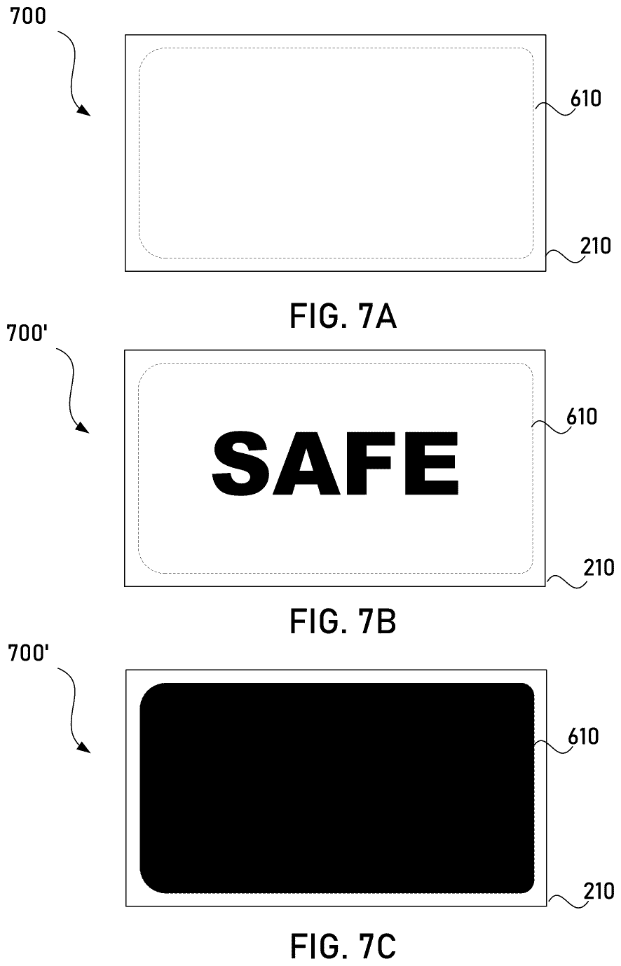

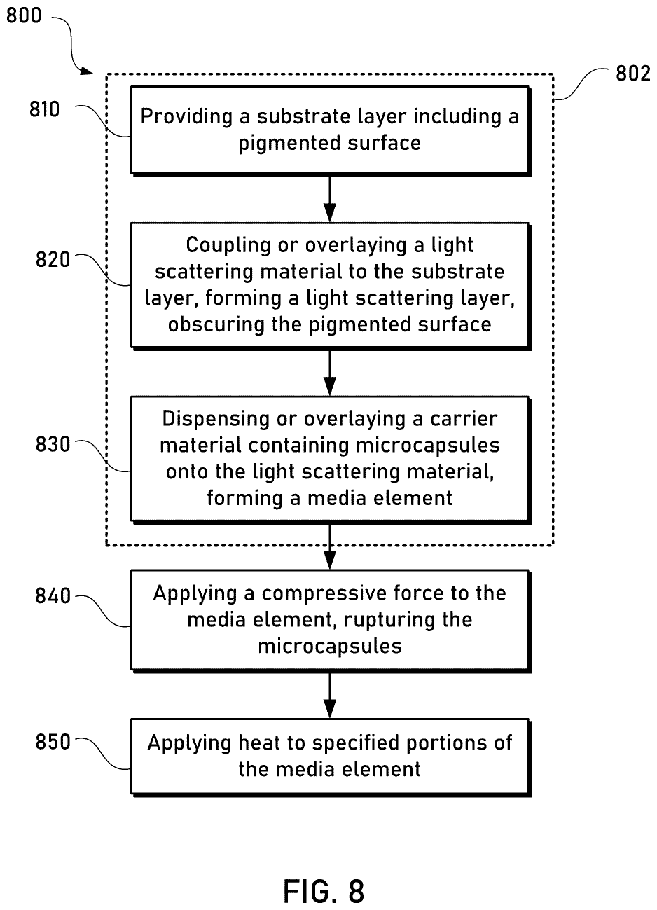

FIGS. 7A-7C illustrate stages a media element (e.g., media element 200, media element 300) configured as a printable activatable environmental exposure indicator 700, according to embodiments of the present disclosure. The printable activatable environmental exposure indicator 700 may include the features of the thermal printable media 600 except where otherwise noted. Generally, the active region is configured as a printable region 610, which also serves as an indicator region. The printable activatable environmental exposure indicator 700 may include microcapsules which contain a payload configured to liquefy responsive to exposure to temperatures above predetermined a predetermined high temperature threshold. A thermal printer may be used to activate the microcapsules in the matrix layer 230 and selectively impart indicia to the printable region 610 by selectively heating portions of the printable region 610 to a temperature above the predetermined high temperature threshold, causing the light scattering layer 220 in the heated portions to transition to the non-obscuring state. Subsequently, when the entire indicator is exposed to a temperature above the predetermined high temperature threshold, the light scattering layer 220 in the remaining portions of the print region 610 transitions to the non-obscuring form, such that the imparted indicia are no longer distinguished in the print region 610.

FIG. 7A illustrates the printable activatable environmental exposure indicator 700 in an initial state, as may be provided to an end user. The light scattering layer 220 in the print region 610 is in the obscuring form.

FIG. 7B illustrates the printable activatable environmental exposure indicator 700 after a thermal printing process and prior to an exposure to ambient temperatures above the predetermined high temperature threshold, according to embodiments of the present disclosure. After the thermal printing process, the microcapsules 100 in the matrix layer are ruptured, having been activated by the nip of the thermal printer, and the payloads 120 respectively released. In the portions of the print region 610 where heating elements of the thermal printer have liquefied the payloads 120, the light scattering layer 220 is in the non-obscuring form, which may form indicia. As illustrated, the indicia are the word “SAFE” to indicate that the printable activatable environmental exposure indicator 700 has not been exposed to ambient temperatures above the high temperature threshold. The indicia may be selected by a user and programmed into the thermal printer accordingly.

In various examples, the print temperature of the thermal printer may be adjusted in accordance with the high temperature threshold which the printable activatable environmental exposure indicator 700 is configured to indicate. Tuning the print temperature within a predetermined range of the predetermined high temperature threshold may contribute to the prevention of over bleed when imparting indicia onto the print region.

FIG. 7C illustrates the printable activatable environmental exposure indicator 700 after the thermal printing process and after exposure to ambient temperatures above the predetermined high temperature threshold. After exposure to ambient temperatures above the predetermined high temperature threshold, the light scattering layer 220 in the remaining or unprinted portion of the print region 610 changes from the obscuring form to the non-obscuring form, revealing the pigmented layer 214 underneath. In this manner the indicia are no longer visibly distinguished from the unprinted portion, indicating that the exposure to ambient temperatures above the predetermined high temperature threshold has occurred.

In various examples of media elements (e.g., media elements 200, 300, activatable environmental exposure indicators 400, 500, thermal printable media elements 600, printable activatable environmental exposure indicators 700) various features may be included, some such features are discussed below.

In some examples, the light scattering layer 220 is formed of a liquefiable material. In some such examples, the light scattering layer 220 is configured to be melted, e.g., by a thermal printer. When the light scattering layer 220 is melted, the voids in the light scattering layer 220 are collapsed, rendering portions of the light scattering layer 220 which have been melted in the non-obscuring state. In such examples, the melted portions of the light scattering layer 220 may be configured to form indicia. In some such embodiments, the microcapsules 100 are resistant to heat activations, such that the microcapsules 100 do not rupture when the light scattering layer 220 is heated to melt the light scattering layer 220.

In some examples, when portions of the light scattering layer 220 are melted and subsequently solidified, the voids in the light scattering layer 220 are collapsed such that the melted and solidified portions form flow barriers. In some such examples, portions of the light scattering layer 220 may be melted to form a border about a particular region of the media element, where any released liquefiable materials within the border do not wick or permeate through the light scattering layer 220 beyond the border. In some examples, microcapsule 100 which are disposed within the bounds of the border may be activated such that only the region within the border transitions from the obscuring form to the non-obscuring form when the payloads 120 are liquefied.

In some examples, media elements (e.g., media elements 200, 300, activatable environmental exposure indicators 400, 500, thermal printable media elements 600, printable activatable environmental exposure indicators 700) may include activation indicators. In such examples, a portion of the microcapsules 100 contain a different type of payload. The portion of microcapsules may be disposed in a particular area of the media element, such as around a periphery of the printable region, or in a corner. Generally, the different type of payload may be a liquid, such that when the microcapsules 100 are activated, the liquid flows into a portion of the light scattering layer 220 and transitions the portion of the light scattering layer 220 from the obscuring state to the non-obscuring state, prior to the application of heat. In this manner, a user may have a visual indication that the microcapsules 100 of the media element have been activated, and that the media element is prepared for printing or environmental sensing.

FIG. 8 illustrates a flowchart for method 800 of forming a media element (e.g., media element 200, media element 300, activatable environmental exposure indicator 400, activatable environmental exposure indicator 500, thermal printable media 600) and subsequently forming indicia on the media element, according to embodiments of the present disclosure.

Block 810 of the method 800 describes providing a substrate layer (e.g., substrate layer 210) including a pigmented surface, according to embodiments of the present disclosure. In some examples, the substrate layer includes a substrate (e.g., substrate 212) and a pigmented layer (e.g., pigmented layer 214) having a first color state and overlaying the substrate. In some examples, the substrate layer further includes a transparent sealing layer (e.g., sealing layer 216) overlaying the pigmented layer. In some examples the substrate layer includes a substrate which is pigmented to have the first color state, or a first surface of the substrate is pigmented to have the first color state. Generally, the substrate layer defines two surfaces, where at least one surface is pigmented to have the first color state, or is overlaid by a transparent layer, such that the surface appears to have the first color state.

In various examples, the pigmented surface may be partially pigmented, so as to include indicia which are visually distinct from other portions of the pigmented surface. In various examples the pigmented surface may be etched. In various examples, the pigmented surface may be devoid of pigment, where the first color state is the color state of the substrate layer.

Block 820 of the method 800 describes coupling or overlaying a light scattering material (e.g., as described in Section I) to the substrate layer, forming a light scattering layer (e.g., light scattering layer 220), according to embodiments of the present disclosure. In some examples, the light scattering material may be dispensed in a particlized form onto the substrate layer (e.g., over the pigmented surface, or the surface having the first color state). In some such examples, the light scattering material may be forcibly compacted, such that voids are formed between the particles to form a light scattering layer. In some examples, the light scattering layer may be provided, and overlaid onto the substrate layer. In some examples, the light scattering material may be dispensed in a liquid or viscous form. In some examples, the light scattering material may be provided as a light scattering film which is overlaid onto the substate layer, forming a light scattering layer.

Generally, the light scattering layer includes voids which act as light scatterers, giving the light scattering material an opaque appearance, which provides for the light scattering layer to obscure the pigmented surface (e.g., or any indica thereupon) of the substrate layer when the light scattering layer overlays the substrate layer. When the voids of the light scattering layer are collapsed or filled, the light scattering effect is abated, and the light scattering material becomes transparent an otherwise non-obscuring.

Block 830 of the method 800 describes dispensing or overlaying a carrier material (e.g., carrier material 232) containing microcapsules (e.g., microcapsules 100) onto the light scattering material, forming a media element (e.g., media element 200, media element 300, activatable environmental exposure indicator 400, activatable environmental exposure indicator 500, thermal printable media 600), according to embodiments of the present disclosure. In various examples, the carrier material may be dispensed in a liquid form containing microcapsules. In some examples, the carrier material is a liquefiable material which is dispends at a dispensation temperature above a liquefication temperature of the carrier material, and upon being deposited onto the light scattering layer (e.g., which includes the light scattering material), the carrier material cools to a temperature below a solidification temperature of the carrier material and solidifies, suspending the microcapsules in a solid matrix. In some examples, the carrier material is a liquid material which is configured to cure or dry after being dispensed, or when subjected to a fixing exposure. In such examples, the carrier material is dispensed containing the microcapsules, whereupon after dispensation the carrier material dries or cures, suspending the microcapsules in a solid matrix. In some examples, a fixing action is required to cure the carrier material, such as an exposure to light of a predetermined wavelength, or an exposure to heat above a predetermined temperature threshold for a predetermined amount of time.

In various examples, the carrier material may be dispensed as a liquid and flood coated over the light scattering layer.

In some examples, the microcapsules may be independently dispensed prior to the dispensation of the carrier material, where the carrier material is dispensed over the microcapsules, and adheres the microcapsules to the light scattering layer. In other examples, the microcapsules may be independently dispensed after the dispensation of the carrier material, where the microcapsules are dispensed into the carrier material which overlays the light scattering layer. In such examples, the microcapsules may be dispensed prior to the carrier material solidifying via cooling, drying or curing.

The microcapsules include a payload microencapsulated in a frangible shell. The payload of the microcapsules includes a liquefiable material which is configured to liquefy when exposed to temperatures above a predetermined temperature threshold, or to a net heat input above a predetermined heat input threshold. The frangible shells are configured to contain the payload prior to the application of an activation action to the media element and release the payload when the activation action is applied to the media element. The activation action may be a compressive force, or one, or a combination of activation actions discussed above in Section I.

In various examples, the steps of blocks 810, 820 and 830 may be performed independently of the remaining steps of the method 800 (e.g., block 840, 850) as a method 802 for forming a media element.

Block 840 of the method 800 describes applying a compressive force to the media element, according to embodiments of the present disclosure. In some examples, the compressive force may be applied by a roller or a press, and in some examples the compressive force may be applied by a nip formed between a platen roller and a thermal printhead of a thermal printer. Generally the compressive force is of a sufficient magnitude to rupture the microcapsules in the carrier material, in a manner which causes the microcapsules to rupture and release the payload.

Block 850 of the method 800 describes applying heat to specified portions of the media element, according to embodiments of the present disclosure. When heat is applied to the specified portions of the media element, the portions of payload located in the specified portions liquefy. The liquefied payload flows into the light scattering layer, where the liquefied payload fills the voids of the light scattering layer, abating the light scattering effect in the specified portions, rendering the light scattering layer transparent and in the non-obscuring form in the specified portions. In this manner, the pigmented surface is viewable to a user through the light scattering layer in the non-obscuring form in the specified portion. The light scattering layer may be configured such that the liquefied payload may only flow down (e.g., in a direction from the matrix layer towards the substrate, the direction orthogonal to a plane of the substrate) and does not spread outwardly (e.g., along the plane of the substrate) such that only the portions of the light scattering layer which are most proximate to the source(s) of applied heat are transitioned from the obscuring state to the non-obscuring state. in this manner, precise indicia may be formed on the thermal printable media 600 as in the portions of the light scattering layer 220 where the voids are filled by the liquefied payload 120′, the pigmented layer 214 is viewable to a user.

In various examples, the heat may be applied to the specified portions of the media element by the heating element of a thermal printhead of a thermal printer during a thermal printing process.

In various examples, the heat may be applied such that the payload in portions of the media element outside of the specified portions is not liquefied by excess heat produced when liquefying the payload in the specified portions. In such examples, the liquefiable material in the payload may be selected or configured to liquefy over a small temperature range (e.g., less than 2 degrees C.) and the heat configured to be applied within the small temperature range, such that an effects of excess heat production are lessened, and the payload in portions of the media element outside of the specified portions is not liquefied.

Furthermore, the steps described by block 740 and 750 may be performed consecutively by a thermal printer during a thermal printing process. After the steps of block 750 the method 700 may be concluded.

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any manner. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain manner is configured in at least that manner but may also be configured in manners that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
an indicator region operatively coupled to the substrate;
a light scattering layer covering a covered portion of the indicator region, the light scattering layer formed of a light scattering material having voids such that the covered portion of the indicator region is obscured; and
a plurality of activatable microcapsules coupled to the substrate;
wherein each activatable microcapsule of the plurality of activatable microcapsules includes a liquefiable material microencapsulated in a frangible shell,
wherein the liquefiable material is configured to liquefy responsive to a predetermined environmental exposure, and
wherein the frangible shells are configured to a) release the liquefiable material responsive to an application of an activation action, and b) contain the liquefiable material prior to the application of the activation action, both before and after the liquifiable material has liquefied,
wherein the plurality of activable microcapsules are coupled to the substrate in a position where the liquefiable material, after being released from the frangible shells and when liquefied, flows into the light scattering layer and fills the voids of the light scattering layer, such that the covered portion of the indicator region becomes unobscured.

2. The activatable environmental exposure indicator of claim 1, wherein the indicator region includes indicia which is initially obscured by the light scattering layer, and when the voids of the light scattering layer are filled, the indicia become unobscured.

3. The activatable environmental exposure indicator of claim 2, wherein the indicia are machine-readable indicia, which is readable through the light scattering layer after the liquefiable material fills the voids and is unreadable through the light scattering layer before the liquefiable material fills the voids.

4. The activatable environmental exposure indicator of claim 1, further comprising a flow inhibiting layer disposed between the light scattering layer and the plurality of activatable microcapsules, the flow inhibiting layer configured to inhibit flow of the liquefiable material into the light scattering layer after the liquefiable material is released from the frangible shells and when the liquefiable material is liquefied, such that the covered portion of the indicator region becomes unobscured after a) the liquefiable material has been released from the frangible shells and b) the liquefiable material has been liquefied for a predetermined duration of time following being released from the frangible shells.

5. The activatable environmental exposure indicator of claim 4, wherein the covered portion of the indicator region becomes unobscured after the activation action is applied to the indicator region and the activatable environmental exposure indicator is subsequently exposed to the predetermined environmental exposure for a predetermined duration of time.

6. The activatable environmental exposure indicator of claim 1, wherein after the liquefiable material fills the voids, the covered portion of the indicator region remains unobscured when the liquefiable material is liquefied, and after the liquefiable material resolidifies.

7. The activatable environmental exposure indicator of claim 1, wherein the activation action is an application of a compression stress exceeding an activation threshold, the activation threshold being in a range of 0.1 pounds per square inch (psi) and 10 psi.

8. The activatable environmental exposure indicator of claim 1, wherein the predetermined environmental exposure is an exposure to an ambient temperature above a predetermined high temperature threshold, an exposure to an ambient temperature above a predetermined high temperature threshold for at least a predetermined amount of time, and a net exposure to ambient heat exceeding a predetermined net heat threshold.

9. The activatable environmental exposure indicator of claim 1, wherein the liquefiable material is selected from a group consisting of a side-chain crystalline polymer, polyalkyl acrylate, an alkane wax, and combinations thereof.

10. The activatable environmental exposure indicator of claim 1, wherein the light scattering layer is formed of a material selected from a group consisting of a side chain crystalline polymer, Polytetrafluoroethylene (PTFE), Ultra High Molecular Weight Polyethylene (UHMW PE), Ultra High Molecular Weight Polypropylene (UHMW PP), High Density Polyethylene (HDPE) Polyvinvylidene Fluoride (PVDF), Perfluoroalkoxy alkane (PFA), Liquid Crystalline Polymer (LPC), and combinations thereof.

11. The activatable environmental exposure indicator of claim 1, wherein the plurality of activatable microcapsules is embedded in a carrier material, the carrier material and the plurality of activatable microcapsules forming a matrix layer overlaying the light scattering layer.

12. A direct thermal printable media, comprising:
a substrate;
a pigmented layer overlaying the substrate;
a light scattering layer overlaying the pigmented layer, the light scattering layer formed of a light scattering material having voids such that the light scattering layer obscures the pigmented layer; and
a plurality of activatable microcapsules;
wherein each microcapsule of the plurality of activatable microcapsules includes a liquefiable material microencapsulated in a frangible shell,
wherein the frangible shells are configured to be ruptured when exposed to a compressive stress above an activation threshold, and configured to release the liquefiable material when ruptured, and
wherein the liquefiable material is configured to liquefy when exposed to heat above a predetermined heat threshold,
wherein after the plurality of activatable microcapsules are coupled to the substrate in a position so that when the liquefiable material is released from the frangible shells and when liquefied, the liquefiable material is flows into the light scattering layer and fill the voids, such that portions of pigmented layer aligned with portions of the light scattering layer where the voids are filled with the liquefiable material become unobscured.

13. A method of forming indicia on a media element, comprising:
providing a substrate layer including a pigmented surface;
overlaying the pigmented surface with a light scattering material, the light scattering material having voids configured to obscure the pigmented surface;
overlaying the light scattering material with a plurality of activatable microcapsules, thus forming a media element,
wherein each microcapsule of the plurality of activatable microcapsules includes a liquefiable material microencapsulated in a frangible shell, and
wherein the frangible shells are configured to be ruptured when exposed to a compressive stress above an activation threshold and release the liquefiable material when ruptured,
wherein the liquefiable material is configured to liquefy when exposed to heat above a predetermined heat threshold,
applying a compressive force to the media element, wherein the compressive force has sufficient magnitude to expose the microcapsules to a compressive stress exceeding the activation threshold, thus rupturing the frangible shells; and
applying heat to specified portions of the media element, wherein the heat applied exceeds the predetermined heat threshold, such that the liquefiable material in the specified portions liquefies and flows into the light scattering material and fills the voids in the specified portions, and the pigmented surface becomes unobscured in the specified portions, thus forming indicia in the specified portions.

14. The method of claim 13, wherein the heat applied to the specified portions is configured to exceed to the predetermined heat threshold in the specified portions but remain below the predetermined heat threshold outside of the specified portions.

15. The method of claim 14, wherein the compressive force is applied by a thermal printer.

16. The method of claim 14, wherein the heat is applied to the specified portions by a thermal printer.

17. A method of forming a media element, comprising:
providing a substrate layer, comprising a pigmented surface;
coupling a light scattering material containing voids to the pigmented surface of the substrate layer, forming a light scattering layer, such that the light scattering material obscures the pigmented surface; and
dispensing, in a liquified state, a carrier material in which a plurality of activatable microcapsules is embedded;
wherein the carrier material is configured to solidify after dispensation, such that each of the plurality of activatable microcapsules are embedded in a solid matrix formed by the carrier material,
wherein each microcapsule of the plurality of activatable microcapsules includes a liquefiable material microencapsulated in a frangible shell,
wherein the frangible shells are configured to a) rupture when exposed to a compressive stress above an activation threshold, releasing the liquefiable material, and b) contain the liquefiable material when liquefied and when solidified, prior to an exposure to the compressive stress above the activation threshold, and
wherein the liquefiable material is configured to liquefy when exposed to a temperature above a predetermined temperature threshold,
wherein after the liquefiable material is released from the frangible shells and when liquefied, the liquefiable material is configured to flow into the light scattering layer and fill the voids, such that the pigmented surface becomes unobscured.

18. The method of claim 17, wherein the carrier material is dispensed at a dispensation temperature greater than the predetermined temperature threshold.

19. The method of claim 18, wherein the carrier material is configured to solidify after dispensation responsive to cooling below a solidification temperature greater than the predetermined temperature threshold and less than the dispensation temperature.

20. The method of claim 17, further comprising, prior to dispensing the carrier material and after coupling the light scattering material to the pigmented surface of the substrate layer, coupling a flow inhibiting layer to the light scattering material, the flow inhibiting layer configured to inhibit flow of the liquefiable material into the light scattering layer after the liquefiable material is released from the frangible shells and when the liquefiable material is liquefied.
